(19) United States
(12) Patent Application Publication
(10) Pub. No.: US 2013/0068408 A1
(43) Pub. Date: Mar. 21, 2013

(54) Fluoropolyether phosphate derivatives

(71) Applicants: Claudio Adolfo Pietro Tonelli, Monza (MB) (IT); Andrea Sergio, Solaro (MI) (IT); Rosaldo Picozzi, Cesate (Milano) (IT); Mahesh Padigala, Bear, DE (US)

(72) Inventors: Claudio Adolfo Pietro Tonelli, Monza (MB) (IT); Andrea Sergio, Solaro (MI) (IT); Rosaldo Picozzi, Cesate (Milano) (IT); Mahesh Padigala, Bear, DE (US)

(73) Assignee: SOLVAY SPECIALTY POLYMERS ITALY S.P.A., Bollate MI (IT)

(21) Appl. No.: 13/700,230

(22) PCT Filed: May 25, 2011
(86) PCT No.: PCT/EP2011/058521

§ 371 Date: Nov. 27, 2012

Related U.S. Application Data
(60) Provisional application No. 61/350,213, filed on Jun. 1, 2010.

(51) Int. Cl. C09D 7/12

(52) U.S. Cl. CPC C09D 7/1233
USPC 162/158; 106/2

(57) ABSTRACT

The invention pertains to an aqueous composition comprising at least one mono-functional (per)fluoropolyether monoester phosphate having formula (I) here below:

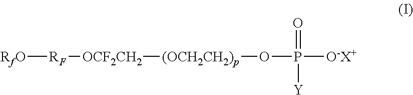

wherein:
R_{f} is a C₁-C₅ (per)fluoroalkyl group optionally containing hydrogen and/or chlorine atoms;
R_{F} is a linear perfluoropolyoxyalkylene chain [chain (R_{F})];
X⁺ is a monovalent cation;
Y is a —OH group or a —O⁻ X⁺ group, wherein X⁺ has the same meaning as defined above;
p is an integer equal to or higher than 1.

### CROSS-REFERENCE TO RELATED APPLICATIONS

This application is a U.S. national stage entry under 35 U.S.C. §371 of International Application No. PCT/EP2011/058521 filed May 25, 2011, which claims priority to U.S. provisional application No. 61/350,213 filed Jun. 1, 2010, the whole content of this application being incorporated herein by reference for all purposes.

### TECHNICAL FIELD

The present invention relates to aqueous compositions of (per)fluoropolyether phosphate derivatives, to a process for the manufacture of said compositions and to use of said compositions for imparting grease and oil repellency to cellulose substrates.

### BACKGROUND ART

Use of fluorochemicals for the treatment of packaging substrates, in particular cellulosic substrates, to impart grease and oil repellency thereto is well known in the art.

In recent years, there has been an increasing demand for grease/oil resistant paper and paper boards. The demand is attributed to the continuously growing packaging markets for food items such as bakery products, pet food, instant and fast foods.

Among commercially available fluorochemical modifiers well-suited for this application, those based on (per)fluoropolyethers have drawn increased attention due to their favourable toxicological profile.

Among techniques for conferring oleo-repellency to substrates, in particular cellulosic substrates, treatments with (per)fluoropolyether derivatives comprising (per)fluoropolyoxyalkylenic chains in a polyurethane backbone (see e.g. WO 2010/000715 A (SOLVAY SOLEXIS S.P.A.) Jul. 1, 2010, EP 1273704 A (AUSIMONT S.P.A.) Aug. 1, 2003) or with (per)fluoropolyether derivatives comprising phosphate groups (see e.g. WO 2010/000715 A (SOLVAY SOLEXIS S.P.A.) Jul. 1, 2010, EP 0687533 A (AUSIMONT S.P.A.) Dec. 20, 1995, EP 1138826 A (AUSIMONT S.PA.) Oct. 4, 2001, EP 1225178 A (SOLVAY SOLEXIS S.P.A.) Jul. 24, 2002 and EP 1371676 A (SOLVAY SOLEXIS S.P.A.) Dec. 17, 2003) or with (per)fluoropolyether derivatives having carboxyl groups (see e.g. WO 2010/000715 A (SOLVAY SOLEXIS S.P.A.) Jul. 1, 2010, EP 1690882 A (SOLVAY SOLEXIS S.P.A.) Aug. 16, 2006, EP 1484445 A (SOLVAY SOLEXIS S.P.A.) Aug. 12, 2004 and EP 1489124 A (SOLVAY SOLEXIS S.P.A.) Dec. 22, 2004) are known.

These (per)fluoropolyether derivatives are typically used in the manufacture process of the paper by wet-end treatment or size-press treatment in a paper machine.

A paper machine is a large de-watering device generally consisting of a head box, a wire section, a press section and a dryer section, wherein starting from a dilute suspension of fibres, and possibly fillers, dyes or other chemicals, which is homogeneously fed onto a fine mesh through which the water drains, the fibres web is conveyed onto subsequent pressing and drying stages.

In the wet-end treatment, the (per)fluoropolyether derivatives are introduced in the initial fibres suspension and caused to deposit onto the fibres during web formation.

When used in the size-press treatment, the (per)fluoropolyether derivative is caused to impregnate the fibres web of paper by passing this latter into a sizing liquid pond located above a roll nip. As a result, the paper web absorbs the sizing liquor including the (per)fluoropolyether derivatives.

One of the main requirements of paper-based packaging suitable for storage of bakery products, pet food, in particular dry pet food, instant and fast foods is a high resistance against staining from the fat in the product, the content of fats in pet food, for example, being typically high and generally ranging between 8% and 27% by weight.

Moreover, while the amount of fluorochemical modifiers required to confer grease and oil repellency to paper depends on the particular application involved, the final cost of the paper produced is also greatly influenced by the cost of the fluorinated material used.

The need was thus felt to have available (per)fluoropolyether derivatives for the treatment of cellulose substrates, in particular paper, which would enable obtaining cost-effective paper-based packaging endowed with improved grease and oil resistance performances, in particular when the amount of fats are higher than 14% by weight, even at lower concentrations of the (per)fluoropolyether derivatives in the paper produced.

### SUMMARY OF INVENTION

It is thus an object of the present invention an aqueous composition comprising at least one mono-functional (per)fluoropolyether monoester phosphate having formula (I) here below:

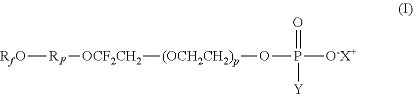

wherein:
R_{F} is a C₁-C₅ (per)fluoroalkyl group optionally containing hydrogen and/or chlorine atoms;
R_{F} is a linear perfluoropolyoxyalkylene chain [chain (R_{F})];
X⁺ is a monovalent cation;
Y is a —OH group or a —O⁻ X⁺ group, wherein X⁺ has the same meaning as defined above;
p is an integer equal to or higher than 1.

The Applicant has found that the mono-functional (per)fluoropolyether monoester phosphate having formula (I) as described above, wherein p is an integer equal to or higher than 1, may be successfully diluted with water to yield a stable aqueous composition thereof which may be suitably applied to cellulose substrates for imparting grease and oil repellency thereto.

It has been also found that mono-functional (per)fluoropolyether monoester phosphates having formula (I) as described above, wherein p is 0, are not stably and quickly dissolved in water to yield aqueous compositions thereof suitable for use in the treatment of cellulose substrates.

The linear (per)fluoropolyoxyalkylene chain [chain (R_{F})] of the mono-functional (per)fluoropolyether monoester phosphate having formula (I) as described above typically comprises one or more recurring units R° having general formula —(CF₂)ⱼ—CKK′—O—, wherein K and K′, equal to or different from each other, independently represent a hydrogen atom, a fluorine atom or a chlorine atom and j is an integer comprised between 0 and 3, said recurring units being generally statistically distributed along the (per)fluoropolyoxyalkylene chain.

The mono-functional (per)fluoropolyether monoester phosphate having formula (I) as described above preferably complies with formula (I-A) here below:

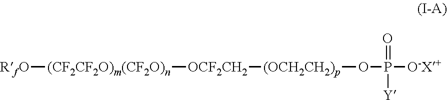

wherein:
R′_{f}O— is selected from CF₃O—, C₂F₅O—, C₃F₇O—, Cl(C₃F₆O)— and H(C₃F₆O)—;
—X′⁺ is selected from Li⁺, Na⁺, K⁺, (NH₃R)⁺, (NH₂R′R″)⁺ and (NHR′R″R′″)⁺ wherein R is H or a linear or branched C₁-C₂₂ alkyl group optionally containing one or more —OH groups, and R′, R″ and R′″, equal to or different from each other, are linear or branched C₁-C₂₂ alkyl groups optionally containing one or more —OH groups or optionally linked to each other to form N-heterocyclic groups;
Y′ is a —OH group or a —O⁻ X′⁺ group, wherein X′⁺ has the same meaning as defined above;
m and n are integers such that the number average molecular weight of the mono-functional (per)fluoropolyether monoester phosphate is comprised between 300 and 8000, preferably between 500 and 3000, the m/n ratio typically ranging between 0.3 and 10;
p is an integer equal to or higher than 1.

The composition of the present invention preferably comprises:
at least one mono-functional (per)fluoropolyether monoester phosphate having formula (I-A1) here below:

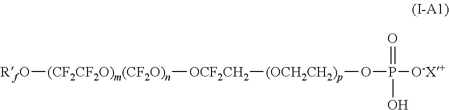

wherein R′_{f}O—, X′⁺, m, n and p have the same meanings as defined above; and
at least one mono-functional (per)fluoropolyether monoester phosphate having formula (I-A2) here below:

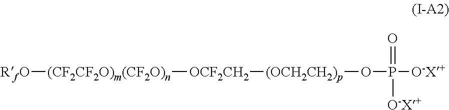

wherein R′_{f}O—, m, n and p have the same meanings as defined above and X′⁺, equal or different at each occurrence, has the same meaning as defined above.

The composition of the present invention may further comprise at least one additional (per)fluoropolyether phosphate derivative selected from the group consisting of:
a mono-functional (per)fluoropolyether diester phosphate having formula (II) here below:

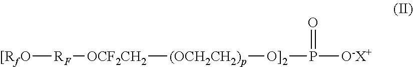

wherein R_{f}, R_{F}, X⁺ and p have the same meanings as defined above; and
a bi-functional (per)fluoropolyether monoester/diester phosphate having formula (III) here below:

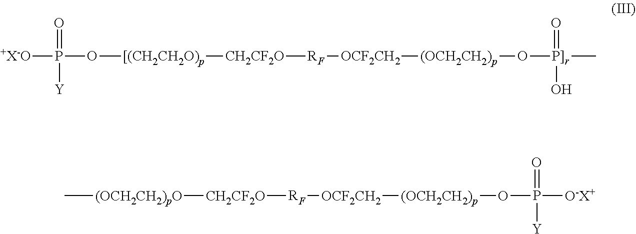

wherein:
R_{F}, X⁺, Y and p have the same meanings as defined above;
r ranges between 0 and 1.

The mono-functional (per)fluoropolyether diester phosphate having formula (II) as described above preferably complies with formula (II-A) here below:

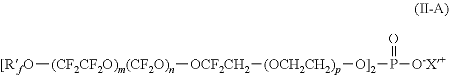

wherein R′_{f}O—, X′⁺, m, n and p have the same meanings as defined above.

The bi-functional (per)fluoropolyether monoester/diester phosphate having formula (III) as described above preferably complies with formula (III-A) here below:

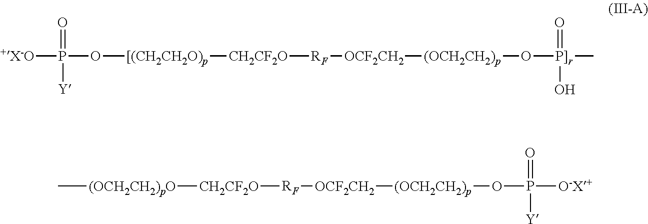

wherein:
R_{F} has formula —(CF₂CF₂O)ₘ(CF₂O)ₙ—, wherein m and n have the same meanings as defined above;
X′⁺, Y′, p and r have the same meanings as defined above.

The composition of the present invention may be under the form of an aqueous solution or an aqueous emulsion.

The composition of the present invention typically comprises more than 50% by weight of water, preferably more than 60% by weight of water.

The aqueous medium may optionally comprise a polar organic solvent.

Among suitable polar organic solvents, mention may be notably made of alcohols, glycols, ethers, esters, alkyl carbonates, ketones and (hetero)cyclic derivatives.

Preferred polar organic solvents are alcohols, glycols and ethers. Non-limitative examples of alcohols suitable for the purpose of the invention include, notably, methanol, ethanol, isopropanol, t-butanol. Non-limitative examples of glycols suitable for the purpose of the invention include, notably, ethylene glycol and propylene glycol. Non-limitative examples of ethers suitable for the purpose of the invention include, notably, dipropylenglycol monomethylether. Isopropanol is more preferred.

The composition of the present invention may optionally further comprise at least one water-dispersible or water-soluble cationic polymer.

The cationic polymer is typically selected from polyamines and/or polyamido-amines generally having a charge density of at least 1 meq/g of dry polymer. Non-limitative examples of suitable cationic polymers include, notably, those disclosed in EP 1690882 A (SOLVAY SOLEXIS S.P.A.) Oct. 16, 2006.

The composition may further comprise any suitable latex known in the art. Non-limitative examples of suitable latexes include, notably, styrene-acrylic copolymer, acrylonitrile styrene-acrylic copolymer, polyvinyl alcohol polymer, acrylic acid polymer, ethylene vinyl alcohol copolymer, ethylene-vinyl chloride copolymer, ethylene vinyl acetate copolymer, vinyl acetate-acrylic copolymer, styrene-butadiene copolymer and vinyl acetate-acrylic copolymer.

Another object of the present invention is a process for the manufacture of the composition as defined above, said process comprising the following steps:
a) a monofunctional alcohol having formula (IV-A) here below:

R_{f}O—R_{F}—OCF₂CH₂—(OCH₂CH₂)ₚ—OH (IV-A)

wherein R_{f}, R_{F} and p have the same meanings as defined above, and, optionally,
a α,ω-diol having formula (IV-B) here below:

HO—(CH₂CH₂O)ₚ—CH₂CF₂O—R_{F}—OCF₂CH₂—(OCH₂CH₂)ₚ—OH (IV-B)

wherein R_{F} and p have the same meanings as defined above, are either
a-1) reacted with phosphoric anhydride in the presence of an amount of water in the range comprised between 1% and 60% by moles, preferably between 5% and 40% by moles with respect to the alcohol equivalents, the equivalent ratio of the alcohol equivalents to the equivalents of phosphoric anhydride being in the range comprised between 1.5:1.0 and 4.0:1.0, preferably between 2.0:1.0 and 3.0:1.0; or
a-2) reacted with pyrophoshoric acid or polyphosphoric acid;
b) the product obtained in step a) of the process is hydrolysed in water or in an aqueous solution of hydrochloric acid, optionally in the presence of a solvent immiscible in water;
c) the final product is separated from the mixture obtained in step b) of the process;
d) the final product recovered from step c) of the process is diluted with water in the presence of a hydroxide of a monovalent cation.

The alcohol precursors of formulae (IV-A) and (IV-B) as described above are obtainable by well known processes of the prior art.

Suitable solvents immiscible in water which may be optionally used for separating the final product from the mixture obtained in step b) of the process of the invention are 2-methyl-1-propanol, methylene chloride, ethyl acetate and other solvents immiscible in water typically known in the art.

When a solvent immiscible in water is used in step b) of the process of the invention, the final product recovered in step c) of the process is typically separated from the mixture obtained in step b) of the process by evaporation of said solvent.

By the process of the invention an aqueous composition comprising at least one mono-functional (per)fluoropolyether monoester phosphate having formula (I) as described above and, optionally, one or more (per)fluoropolyether phosphate derivatives having formulae (II) and/or (III) as described above is obtained.

The phosphatization reaction of step a) of the process of the invention is carried out at temperatures typically in the range comprised between 20° C. and 120° C., preferably between 40° C. and 100° C. It has been found that in this temperature range the mole ratio of (per)fluoropolyether monoester phosphates to (per)fluoropolyether diester phosphates obtained by the process of the invention is advantageously independent on the temperature itself.

It has been also found that, when phosphoric anhydride is used in step a-1) of the process of the invention, the mole ratio of one or more (per)fluoropolyether monoester phosphates to one or more (per)fluoropolyether diester phosphates obtained by the process of the invention is dependent on the mole ratio of water to phosphoric anhydride used in step a-1) of the process of the invention. Alternatively, when pyrophosphoric or polyphosphoric anhydride is used in step a-2) of the process of the invention, one or more (per)fluoropolyether monoester phosphates are selectively obtained by the process of the invention.

A further object of the present invention is a process for imparting grease and oil repellency to the surface of a cellulose substrate, said process comprising applying internally or externally to the surface of the cellulose substrate the aqueous composition as defined above.

The Applicant has found that by means of the process of the present invention it is possible to successfully confer very good grease and oil repellence properties to cellulose substrates while advantageously reducing the total amount of (per)fluoropolyether phosphate additives required for the target properties.

Good results have been obtained with aqueous compositions according to the invention having a pH value of at least 7.

Very good results have been obtained with aqueous compositions according to the invention having a pH value comprised between 7 and 8.

Cellulose substrates typically used in the process of the invention include, notably, those used in packaging applications.

Non-limitative examples of cellulose substrates suitable for the process of the invention include, notably, paper-like substrates, e.g., kraft papers, paper boards like, e.g., solid bleached sulphite paper boards and other cellulosic fibre assemblies.

In the process for imparting grease and oil repellency internally or externally to the surface of cellulose substrates, the aqueous composition of the invention is typically applied internally by wet-end techniques or externally by size-press techniques.

In the wet-end treatment, the aqueous composition of the invention is typically added to a cellulose slurry before the paper formation in an amount such that the dosage of at least one mono-functional (per)fluoropolyether monoester phosphate having formula (I) as described above and, optionally, one or more (per)fluoropolyether phosphate derivatives having formulae (II) and/or (III) as described above is in the range generally comprised between 0.1% and 2.0% by weight, preferably between 0.1% and 0.5% by weight with respect to the weight of dry cellulose.

The cellulose slurry may be formed by hard wood or soft wood, obtained by kraft and/or sulphite process, suitably refined, or by recycled cellulose slurries or also by admixtures of different cellulose slurries. The concentration of dry cellulose in the slurry typically ranges from 0.1% to 10% by weight.

The cellulose slurry may also contain other additives typically used in the paper industry, for example organic or inorganic fillers such as talc, kaolin, calcium carbonate or titanium dioxide, coadjuvant agents such as starches, dextrins, retention aids, flocculating agents, buffer systems, fungicides, biocides, chelating agents, glue agents such as alkenyl succinic anhydride or alkyl ketene dimer.

The cellulose slurry may have acid or basic pH values, preferably basic pH values.

After the addition of the aqueous composition of the invention to the cellulose slurry, the water is typically removed obtaining a wet paper which is typically dried at temperatures generally in the range comprised between 90° C. and 130° C., according to the standard procedures used in the paper industry.

In the size-press treatment of the preformed paper, the aqueous composition of the invention is typically applied on both sides of the paper by suitable continuous equipments (size-press) in line with the paper machine. The amount of the aqueous composition of the invention used in this size-press treatment is such as to have a content of at least one mono-functional (per)fluoropolyether monoester phosphate having formula (I) as described above and, optionally, one or more (per)fluoropolyether phosphate derivatives having formulae (II) and/or (III) as described above in the range generally comprised between 0.1% and 1.0% by weight, preferably between 0.1% and 0.8% by weight with respect to the weight of dry cellulose.

Should the disclosure of any patents, patent applications, and publications which are incorporated herein by reference conflict with the description of the present application to the extent that it may render a term unclear, the present description shall take precedence.

### DETAILED DESCRIPTION OF THE EMBODIMENTS

The invention will be now described in more detail with reference to the following examples, whose purpose is merely illustrative and not limiting the scope of the invention.

### Raw Materials

(A) SOLVERA® PT5071 PFPE having formula HOOCCF₂(OCF₂CF₂)ₘ(OCF₂)ₙOCF₂COOH, wherein m and n are integers such that the number average molecular weight is 1500, the ratio m/n ranging between 2 and 3.
(B) SOLVERA® PT5045 PFPE having formula (HO)₂P(O)[(OCH₂CH₂)ₚOCH₂—R_{F}—CH₂O(CH₂CH₂O)ₚP(O)OH]_{0.1}(OCH₂CH₂)ₚOCH₂—R_{F}—CH₂O(CH₂CH₂O)ₚP(O)(OH)₂, wherein R_{F} has formula —CF₂(OCF₂CF₂)ₘ(OCF₂)ₙOCF₂—, m and n are integers such that the number average molecular weight is 1500, the m/n ratio ranging between 2 and 3, and p is 1.8.

### Test Methods

### Kit Test

This test was carried out under the same conditions as detailed in EP 1690882 A (SOLVAY SOLEXIS S.P.A.) Oct. 16, 2006.

The higher the rating, the better is the oil repellence of the substrate. Fatty Acid Test (NFA Test)

This test was carried out by contacting a paper specimen with a series of fatty acid solutions numbered from 1 to 11 (from less to most aggressive) prepared by blending different amounts of castor oil, oleic acid and octanoic acid.

Specimens of substrates were introduced in an oven maintained at 60° C. and 5 drops of each test solution were dipped onto each sample. After 5 minutes at 60° C., oil drops were removed with absorbent tissue and substrates were inspected for darkening of surface.

Rating of a substrate corresponds to the highest number of the fatty acid solution which causes no alteration to the surface.

### Pet Food Test

### US Standard

This test was carried out under the same conditions as detailed in EP 1690882 A (SOLVAY SOLEXIS S.P.A.) Oct. 16, 2006.

The test result is expressed in terms of percentage of stained surface. The test is considered positive if the stained surface is lower than 2%.

### Pet Food Test

### EU Standard

This test was carried out under the same conditions used for the Pet Food US Standard test but using 100 ml of ungrinded pet food, namely croquettes with a raw fat content of 19% by weight, and operating at 60° C. under a relative humidity of 65% under a weight of 3 Kg for 24 hours.

The test result is expressed in terms of percentage of stained surface. The test is considered positive if the stained surface is lower than 2%.

### Ralston Crease Test (RP-2 Test)

This test was carried out under the same conditions as detailed in EP 1690882 A (SOLVAY SOLEXIS S.P.A.) Oct. 16, 2006.

The test result is expressed in terms of percentage of stained squares of the grid. The test is considered positive if the stained surface is lower than 2%.

### Synthesis of (Per)Fluoropolyether Phosphate Derivatives

### Example 1

80 g (0.16 equivalents) of a mono-functional perfluoropolyoxyalkylene alcohol of formula CF₃O(CF₂CF₂O)ₘ(CF₂O)ₙCF₂CH₂O(CH₂CH₂O)ₚH having a number average molecular weight of 606, wherein the m/n ratio is 2 and p is 1.64, and 0.9 g of demineralised water were introduced into a 250 ml flask, equipped with a mechanical stirrer. 13 g (0.09 moles) of P₂O₅ were then added under stirring in a single portion. The temperature inside the reactor was increased from 25° C. up to 65° C. in about 40 minutes, then set up to 100° C. and left under these conditions for about six hours.

After cooling to 70° C., a mixture of 18 g of 2-methyl-1-propanol and 85 g of a 2% by weight aqueous solution of HCl were added thereto and the reaction mixture was left under stirring at 70° C. for about three hours. The organic phase obtained was stripped at 100° C. and 1.3 mbar.

Complete conversion of the alcohol precursor was obtained.

By ³¹P-NMR analysis, the mole ratio between monoester and diester groups in the mono-functional (per)fluoropolyether phosphate product obtained (82 g) was found to be 70:30.

### Example 2

80 g (0.13 equivalents) of a monofunctional perfluoropolyoxyalkylene alcohol of formula CF₃O(CF₂CF₂O)ₘ(CF₂O)ₙCF₂CH₂O(CH₂CH₂O)ₚH having a number average molecular weight of 599, wherein the m/n ratio is 2 and p is 1.74, were introduced into a 250 ml flask, equipped with a mechanical stirrer. 35.2 g (0.20 moles) of H₄P₂O₇ were then added under stirring in a single portion. The temperature inside the reactor was set up to 90° C. and left under these conditions for about six hours.

After cooling to 70° C., a mixture of 18 g of 2-methyl-1-propanol and 85 g of a 2% by weight aqueous solution of HCl were added thereto and the reaction mixture was left under stirring at 70° C. for about three hours. The organic phase obtained was stripped at 100° C. and 1.3 mbar.

Complete conversion of the alcohol precursor was obtained.

As confirmed by ³¹P-NMR analysis, the product having formula CF₃O(CF₂CF₂O)ₘ(CF₂O)ₙCF₂CH₂O(CH₂CH₂O)ₚP(O)(OH)₂ was obtained (88 g) having a number average molecular weight of 680, wherein the m/n ratio is 2 and p is 1.74.

### Example 3

80 g (0.13 equivalents) of a mixture of a mono-functional perfluoropolyoxyalkylene alcohol of formula CF₃O(CF₂CF₂O)ₘ(CF₂O)ₙCF₂CH₂O(CH₂CH₂O)ₚH and a bi-functional perfluoropolyoxyalkylene alcohol of formula H(OCH₂CH₂)ₚOCH₂CF₂O(CF₂CF₂O)ₘ(CF₂O)ₙCF₂CH₂O(CH₂CH₂O)ₚH in a mole ratio of 4:6, having a number average molecular weight of 1760 and a number average equivalent weight of 1100, wherein the m/n ratio is 1.6 and p is 1.66, and 0.8 g of demineralised water were introduced into a 250 ml flask, equipped with a mechanical stirrer. 12 g (0.08 moles) of P₂O₅ were then added under stirring in a single portion. The temperature inside the reactor was increased from 25° C. up to 65° C. in about 40 minutes, then set up to 90° C. and left under these conditions for about six hours.

After cooling to 70° C., a mixture of 18 g of 2-methyl-1-propanol and 85 g of a 2% by weight aqueous solution of HCl were added thereto and the reaction mixture was left under stirring at 70° C. for about three hours. The organic phase obtained was stripped at 100° C. and 1.3 mbar.

Complete conversion of the alcohol precursor was obtained.

By ³¹P-NMR analysis, the mole ratio between monoester and diester groups in the (per)fluoropolyether phosphate product obtained (82 g), having an average functionality of 1.6, was found to be 85:15.

### Example 4

80 g (0.13 equivalents) of a mixture of a mono-functional perfluoropolyoxyalkylene alcohol of formula CF₃O(CF₂CF₂O)ₘ(CF₂O)ₙCF₂CH₂O(CH₂CH₂O)ₚH and a bi-functional perfluoropolyoxyalkylene alcohol of formula H(OCH₂CH₂)ₚOCH₂CF₂O(CF₂CF₂O)ₘ(CF₂O)ₙCF₂CH₂O(CH₂CH₂O)ₚH in a mole ratio of 4:6, having a number average molecular weight of 1760 and a number average equivalent weight of 1100, wherein the m/n ratio is 1.6 and p is 1.66, were introduced into a 250 ml flask, equipped with a mechanical stirrer. 19.4 g (0.11 moles) of H₄P₂O₇ were then added under stirring in a single portion. The temperature inside the reactor was set up to 90° C. and left under these conditions for about six hours.

After cooling to 70° C., a mixture of 18 g of 2-methyl-1-propanol and 85 g of a 2% wt. aqueous solution of HCl were added thereto and the reaction mixture was left under stirring at 70° C. for about three hours. The organic phase obtained was stripped at 100° C. and 1.3 mbar.

Complete conversion of the alcohol precursor was obtained.

As confirmed by ³¹P-NMR analysis, a mixture of a mono-functional perfluoropolyether monoester phosphate of formula CF₃O(CF₂CF₂O)ₘ(CF₂O)ₙCF₂CH₂O(CH₂CH₂O)ₚP(O)(OH)₂ and a bi-functional perfluoropolyether monoester phosphate of formula (HO)₂(O)P(OCH₂CH₂)ₚOCH₂CF₂O(CF₂CF₂O)ₘ(CF₂O)ₙCF₂CH₂O(CH₂CH₂O)ₚP(O)(OH)₂ in a mole ratio of 4:6, wherein the m/n ratio is 1.6 and p is 1.66, was obtained (85 g).

### Comparative Example 1

The same procedure as detailed in Example 1 of the invention was followed but using a mono-functional perfluoropolyoxyalkylene alcohol of formula CF₃O(CF₂CF₂O)ₘ(CF₂O)ₙCF₂CH₂OH having a number average molecular weight of 500, wherein the m/n ratio is 2.

By ³¹P-NMR analysis, the mole ratio between monoester and diester groups in the mono-functional (per)fluoropolyether phosphate product obtained was found to be 70:30.

The net product gave 5% hydrolysis after five months at ambient conditions.

### Comparative Example 2

The same procedure as detailed in Example 2 of the invention was followed but using a mono-functional perfluoropolyoxyalkylene alcohol of formula CF₃O(CF₂CF₂O)ₘ(CF₂O)ₙCF₂CH₂OH having a number average molecular weight of 500, wherein the m/n ratio is 2.

No conversion of the alcohol precursor into the corresponding perfluoropolyether phosphate was observed.

### Preparation of the Compositions

### Example 5

A composition was prepared by diluting with water the product obtained as detailed in Example 2 of the invention and by adding thereto ammonium hydroxide until a pH value of 7-8 was reached at a concentration of 20% by weight of the aqueous composition so obtained.

### Example 6

A composition was prepared by mixing in a 20:80 weight ratio the aqueous composition prepared as detailed in Example 5 of the invention and a 20% by weight aqueous composition of the ammonium salt of SOLVERA® PT5071 bi-functional perfluoropolyether carboxylate (Example 6a) or a 20% by weight aqueous composition of the ammonium salt of SOLVERA® PT5045 bi-functional perfluoropolyether diester phosphate (Example 6b).

### Example 7

A composition was prepared by mixing in a 30:70 weight ratio the aqueous composition prepared as detailed in Example 5 of the invention and a 20% by weight aqueous composition of the ammonium salt of SOLVERA® PT5045 bi-functional perfluoropolyether diester phosphate.

### Comparative Example 3

The product obtained as detailed in Comparative Example 1 was found to hydrolyse when diluted with water under the same conditions as detailed in Example 5 of the invention. The composition so obtained gave 20% hydrolysis after two months at ambient conditions and was thus not suitable for use in the treatment of paper where the (per)fluoropolyether additive is requested to be stably and quickly dissolved in water.

### Comparative Example 4

A composition was prepared by diluting with water at a concentration of 20% by weight the ammonium salt of SOLVERA® PT5071 bi-functional perfluoropolyether carboxylate (comparative Example 4a) or the ammonium salt of SOLVERA® PT5045 bi-functional perfluoropolyether diester phosphate (comparative Example 4b).

### Wet-End Paper Treatment

A cellulose slurry was used containing refined soft wood and hard wood in a weight ratio of 50:50, a waxy maize cationic starch, a polyamine epichlorohydrin resin cationic retention aid and an anionic flocculating agent.

The compositions prepared as detailed in Examples 5 and 6a of the invention and in comparative Example 4a were diluted with water to 1% by weight and added to the cellulose slurry at the dosage of the net (per)fluoropolyether additives in the dry cellulose as set forth in Table 1 here below.

The starch, the retention aid and the flocculating agent were applied in an amount of 0.25% by weight, 0.25% by weight and 0.05% by weight, respectively, with respect to the weight of dry cellulose.

Hand sheets were made using a British hand sheet mold. The hand sheets were then pressed using an automatic sheet press to remove excess water from the paper. The paper was dried on a bench top drier at 105° C. for few seconds. The weight of the obtained paper specimen was 81 g/m².

TABLE 1

| | | Fluorine | | | | |
|---|---|---|---|---|---|---|
| | Dosage | on dry | | | | |
| | PFPE | paper | | NFA | Pet Food | RP-2 |
| Run | [g/Kg paper] | [% wt.] | Kit Test | Test | US Test | Test |
| Ex. 5 | 2.0 | 0.06% | 7 | 10.0 | 0% | 0% |
| Ex. 5 | 1.5 | 0.06% | 6 | 10.0 | 0.25% | 0% |
| Ex. 6a | 2.5 | 0.11% | 8 | 10.0 | 0% | 0% |
| Ex. 6a | 2.0 | 0.11% | 8 | 10.0 | 0% | 0% |
| C. Ex. 4a | 3.0 | 0.15% | 7 | 5.5 | 100% | 0% |
| C. Ex. 4a | 4.0 | 0.19% | 7 | 7.0 | 50% | 0% |
| C. Ex. 4a | 5.0 | 0.21% | 9 | 7.5 | 63% | 0% |

### Size-Press Paper Treatment

The compositions prepared as detailed in Examples 5 and 6b of the invention and in comparative Example 4b were diluted with water to the concentrations as set forth in Table 2 here below and applied to bleached kraft paper sheets by a laboratory size-press equipment.

The wet sheets were dried in press at 105° C. for 2 minutes.

TABLE 2

| | | | | | Pet | |
|---|---|---|---|---|---|---|
| | | Fluorine on | | | Food | |
| | Concentration | dry paper | Kit | NFA | US | RP-2 |
| Run | [% wt.] | [% wt.] | Test | Test | Test | Test |
| Ex. 5 | 1.00% | 0.17% | 9 | 5 | 0% | 0% |
| Ex. 5 | 1.25% | 0.19% | 9 | 6 | 0% | 0% |
| Ex. 5 | 1.50% | 0.23% | 10 | 6 | 0% | 0% |
| Ex. 6b | 1.00% | 0.19% | 8 | 3 | 0% | 0% |
| Ex. 6b | 1.25% | 0.22% | 9 | 4 | 0% | 0.1% |
| Ex. 6b | 1.50% | 0.25% | 9 | 4 | 0% | 0% |
| C. Ex. 4b | 1.00% | 0.18% | 7 | 1 | 100% | 0.5% |
| C. Ex. 4b | 1.25% | 0.21% | 7 | 1 | 100% | 1.5% |
| C. Ex. 4b | 1.50% | 0.26% | 7 | 2 | 100% | 0.3% |

The data reported in Tables 1 and 2 here above have shown that the aqueous compositions of the invention, said compositions comprising at least one monofunctional (per)fluoropolyether monoester phosphate having formula (I) as described above, as represented by the aqueous compositions of Examples 5 and 6 of the invention, may be successfully used in the treatment of paper to confer very good grease and oil repellence properties thereto, even at lower fluorine content based on the weight of dry cellulose, as compared with aqueous compositions of SOLVERA® PT5071 and SOLVERA® PT5045 fluoropolyether additives.

Also, the compositions prepared as detailed in Examples 5 and 7 of the invention and in comparative Example 4b were diluted with water to the concentrations as set forth in Table 3 here below and applied to bleached kraft paper sheets by a laboratory size-press equipment, in the presence of a starch and a sizing agent.

The wet sheets were dried in press at 105° C. for 2 minutes.

TABLE 3

| | Concentration | | NFA | Pet Food |
|---|---|---|---|---|
| Run | [% wt.] | Kit Test | Test | EU Test |
| Ex. 5 | 1.0% wt. | 6 | 3 | 2% |
| Ex. 5 | 1.5% wt. | 7 | 3 | 1% |
| Ex. 7 | 1.5% wt. | 6 | 3 | 2% |
| C. Ex. 4b | 1.0% wt. | 5 | 2 | 100% |
| C. Ex. 4b | 1.5% wt. | 6 | 2 | 90% |

The data reported in Table 3 here above have shown that the aqueous compositions of the invention, said compositions comprising at least one monofunctional (per)fluoropolyether monoester phosphate having formula (I) as described above, as represented by the aqueous compositions of Examples 5 and 7 of the invention, may be successfully used in the treatment of paper to confer very good grease and oil repellence properties thereto, even under more realistic Pet Food EU Standard test conditions, as compared with aqueous compositions of SOLVERA® PT5045 fluoropolyether additive.

1. An aqueous composition comprising at least one mono-functional (per)fluoropolyether monoester phosphate having formula (I) here below: 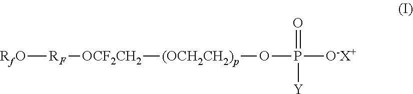
wherein:
R_{f} is a C₁-C₅ (per)fluoroalkyl group optionally containing hydrogen and/or chlorine atoms;
R_{F} is a linear perfluoropolyoxyalkylene chain [chain (R_{F})];
X⁺ is a monovalent cation;
Y is a —OH group or a —O⁻ X⁺ group, wherein X⁺ has the same meaning as defined above; and
p is an integer equal to or higher than 1.

2. The aqueous composition of claim 1, wherein the mono-functional (per)fluoropolyether monoester phosphate complies with formula (I-A) here below: 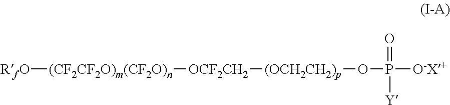
wherein:
R′_{f}O— is selected from the group consisting of CF₃O—, C₂F₅O—, C₃F₇O—, Cl(C₃F₆O)— and H(C₃F₆O)—;
X′⁺ is selected from the group consisting of Li⁺, Na⁺, K⁺, (NH₃R)⁺, (NH₂R′R″)⁺ and (NHR′R″R′″)⁺ wherein R is H or a linear or branched C₁-C₂₂ alkyl group optionally containing one or more —OH groups, and R′, R″ and R′″, equal to or different from each other, are linear or branched C₁-C₂₂ alkyl groups optionally containing one or more —OH groups or optionally linked to each other to form N-heterocyclic groups;
Y′ is a —OH group or a —O⁻ X′⁺ group, wherein X′⁺ has the same meaning as defined above;
m and n are integers such that the number average molecular weight of the mono-functional (per)fluoropolyether monoester phosphate is comprised between 300 and 8000, the m/n ratio typically ranging between 0.3 and 10; and
p is an integer equal to or higher than 1.

3. The aqueous composition of claim 2, said composition comprising:
at least one mono-functional (per)fluoropolyether monoester phosphate having formula (I-A1) here below: 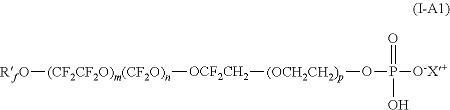
wherein R′_{f}O—, X′⁺, m, n and p have the same meanings as defined in claim 2; and
at least one mono-functional (per)fluoropolyether monoester phosphate having formula (I-A2) here below: 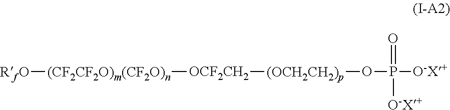
wherein R′_{f}O—, m, n and p have the same meanings as defined in claim 2 and X′⁺, equal or different at each occurrence, has the same meaning as defined in claim 2.

4. The aqueous composition of claim 1, said composition further comprising at least one additional (per)fluoropolyether phosphate derivative selected from the group consisting of:
a mono-functional (per)fluoropolyether diester phosphate having formula (II) here below: 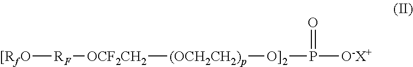
wherein R_{f}, R_{F}, X⁺ and p have the same meanings as defined in claim 1; and
a bi-functional (per)fluoropolyether monoester/diester phosphate having formula (III) here below: 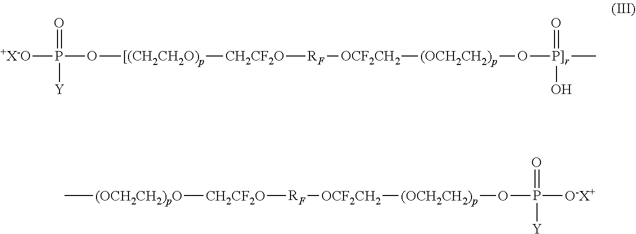
wherein:
R_{F}, X⁺, Y and p have the same meanings as defined in claim 1;
r ranges between 0 and 1.

5. A process of manufacturing an aqueous composition comprising at least one mono-functional (per)fluoropolyether monoester phosphate,
said mono-functional (per)fluoropolyether monoester phosphate has formula (I) here below: 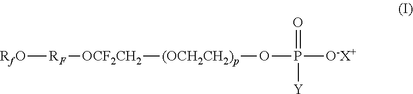
wherein:
R_{f} is a C₁-C₅ (per)fluoroalkyl group optionally containing hydrogen and/or chlorine atoms;
R_{F} is a linear perfluoropolyoxyalkylene chain [chain (R_{F})];
X⁺ is a monovalent cation;
Y is a —OH group or a —O⁻ X⁺ group, wherein X⁺ has the same meaning as defined above; and
p is an integer equal to or higher than 1; and, said process comprising the following steps:
a) providing a monofunctional alcohol having formula (IV-A) here below:
R_{f}O—R_{F}—OCF₂CH₂—(OCH₂CH₂)ₚ—OH (IV-A)
wherein
R_{f} is a C₁-C₅ (per)fluoroalkyl group optionally containing hydrogen and/or chlorine atoms;
R_{F} is a linear perfluoropolyoxyalkylene chain [chain (R_{F})];
p is an integer equal to or higher than 1;
and, optionally,
providing a α,ω-diol having formula (IV-B) here below:
HO—(CH₂CH₂O)ₚ—CH₂CF₂O—R_{F}—OCF₂CH₂—(OCH₂CH₂)ₚ—OH (IV-B)
wherein
R_{F} is a linear perfluoropolyoxyalkylene chain [chain (R_{F})];
p is an integer equal to or higher than 1;
and
a-1) reacting said monofunctional alcohol and, optionally, said α,ω-diol with phosphoric anhydride in the presence of an amount of water in the range comprised between 1% and 60% by moles with respect to the alcohol equivalents, the equivalent ratio of the alcohol equivalents to the equivalents of phosphoric anhydride being in the range comprised between 1.5:1.0 and 4.0:1.0; or
a-2) reacting said monofunctional alcohol and, optionally, said α,ω-diol with pyrophoshoric acid or polyphosphoric acid to produce a product;
b) hydrolysing the product obtained in step a) of the process in water or in an aqueous solution of hydrochloric acid, optionally in the presence of a solvent immiscible in water to produce a final product;
c) separating and recovering the final product from the mixture obtained in step b) of the process; and
d) diluting the final product recovered from step c) of the process with water in the presence of a hydroxide of a monovalent cation.

6. A process for imparting grease and oil repellency to the surface of a cellulose substrate, said process comprising applying internally or externally to the surface of the cellulose substrate the aqueous composition of claim 1.

7. The process of claim 6, wherein the aqueous composition has a pH value of at least 7.

8. The process of claim 6, wherein the aqueous composition is applied internally by wet-end techniques or externally by size-press techniques.
